(19) United States
(12) Patent Application Publication
(10) Pub. No.: US 2003/0097335 A1
(43) Pub. Date: May 22, 2003

(54) Secure method and system for determining charges and assuring privacy

(75) Inventors: Paul A. Moskowitz, Yorktown Heights, NY (US); Charles P. Tresser, New York, NY (US); Robert J. von Gutfeld, New York, NY (US)

Correspondence Address: HOFFMAN WARNICK & D'ALESSANDRO, LLC, 3 E-COMM SQUARE, ALBANY, NY, 12207

(73) Assignee: International Business Machines Corporation, Armonk, NY

(21) Appl. No.: 09/990,842

(22) Filed: Nov. 21, 2001

(51) Int. Cl. G06F 17/60

(52) U.S. Cl. 705/52

(57) ABSTRACT

A system and method for processing usage data within a local data processing system installed on a remote apparatus. The system comprises: a central server for receiving information from the remote apparatus, and processing the information to obtain a usage payment; and a local data processing system installed on the remote apparatus, having: a monitoring system for gathering usage data from the remote apparatus; a processor for managing the usage data; a communications system for communicating information from the processor to the central server; and a security system, wherein the security system includes an encryption system for securing information transmitted to the central server, and for securing information processed by the central server.

### BACKGROUND OF THE INVENTION

1. Technical Field

The present invention relates to data collection and security systems, and more specifically relates to a system and method for securely collecting usage data from remotely located apparatuses.

2. Related Art

Methods have been established for determining insurance or rental charges for the operation of motor vehicles based on actual usage. For example, in U.S. Pat. No. 5,797,134, “Motor Vehicle Monitoring System For Determining A Cost Of Insurance,” which is hereby incorporated by reference, a system is provided for basing auto insurance charges on data collected directly from the driver's car. The system monitors various driving characteristics (e.g., location, speed, seatbelt usage, etc.), which are then uploaded to a company, where a cost to the insured is calculated. Similar systems have been suggested for determining automobile rental charges. Other relevant systems, which are hereby incorporated by reference, include U.S. Pat. No. 5,570,087, issued to Lemelson, “Motor Vehicle Performance Monitor and Method”; U.S. Pat. No. 5,805,079, issued to Lemelson, “Motor Vehicle Performance Monitor and Method”; and U.S. Pat. No. 6,064,970, issued to McMillan et al., “Motor Vehicle Monitoring System For Determining A Cost Of Insurance.”

Unfortunately, present day methods for collecting such information do not assure security or privacy of the supplied data. For instance, data that is gathered by an insurance company to calculate rates (such as where and when the insured traveled in their car) may become available to others. Despite the promises of insurance companies to keep the data gathered on individuals private, anyone who has access to the computing system of the insurance company or the transmission channel may have access to the private data of the individual subscriber. Such data may easily be compromised and used in an unauthorized manner. The company possessing the data could also compromise the privacy of the subscriber by, for example, selling the information to telemarketers, etc. Accordingly, a need exists to provide a data collection system that will ensure privacy, security and confidentiality to users of the system.

Moreover, while the related art teaches collecting usage information as a basis for insurance and rental rates for an automobile, the related art fails to teach applications for other apparatuses where usage information could be used to determine rental and insurance costs. Accordingly, a need exists to address the above-mentioned issues.

### SUMMARY OF THE INVENTION

The present invention addresses the above-mentioned problems, as well as others, by providing a system for managing usage data collected from a remote apparatus. In a first aspect, the invention provides a system for processing usage data within a local data processing system installed on a remote apparatus, wherein the local data processing system comprises: a sensor for gathering usage data from the remote apparatus; and a processor for processing the gathered usage data and calculating a charge based on the gathered usage data.

In a second aspect, the invention provides a system for managing usage data collected on a remote apparatus, comprising: a local data processing system having: a monitoring system for gathering usage data from the remote apparatus; a processor for processing the usage data; a communications system for communicating the processed usage data; and a security system for securing the usage data.

In a third aspect, the invention provides a system for managing usage information collected on a remote apparatus, comprising: a central server for receiving information from the remote apparatus, and processing the information to obtain a usage payment; and a local data processing system installed on the remote apparatus, having: a monitoring system for gathering usage data from the remote apparatus; a processor for managing the usage data; a communications system for communicating information from the processor to the central server; and a security system, wherein the security system includes an encryption system for securing information transmitted to the central server, and for securing information processed by the central server.

In a fourth aspect, the invention provides a method of securely communicating data between remote apparatuses and a central server, comprising the steps of: generating data D on a first apparatus; encrypting the data D with a first key K to generate K(D); transmitting K(D) to a secure partner of the central server; decrypting K(D) at the secure partner to recover D; appending a tag T to D and encrypting D and T with a second key k to generate k(D,T), wherein T associates data D with the first apparatus; transmitting k(D,T) to the central server; decrypting k(D,T) at the central server to recover D and T; and processing data D at the central server.

In a fifth aspect, the invention provides a method for managing usage data collected on a remote apparatus, comprising: providing a sensor on the remote apparatus to gather usage data; communicating the usage data to a processor located on the remote apparatus; calculating a charge on the processor based on the usage data; and communicating the charge to a server via a wireless transmission channel.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a remote usage monitoring system in accordance with an embodiment of the present invention.

FIG. 2 depicts vehicle data processing system.

FIG. 3 depicts a vehicle having the data processing system of FIG. 2.

FIG. 4 depicts a secure usage monitoring system.

FIG. 5 depicts a software stack for a local computing system.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

I. Overview

The present invention provides a secure system for monitoring the use of a vehicle or other apparatus; for calculating a “charge” (e.g., a cost, rate, charge, fee, etc.); for storage of usage information and information related to the operation of the vehicle/apparatus; and for obtaining payment. The charges may be calculated and relayed to a central server where payment may be secured by means of a credit card payment system. The charges may be added to produce a total sum or may be divided into increments of time or usage. Using the credit card payment system, mini-payments for incremental usage may be obtained. This may change or lower the total cost of insurance with respect to a fixed price insurance policy. In addition to fee or charge determination, the calculations may be used to determine risk. For example, if a driver is found to engage in an excess of undesired activity, e.g. speeding, then that driver maybe assigned to a high-risk group of subscribers. In the case of a rented apparatus, the system can measure aberrant usage and make the necessary adjustments to rental costs.

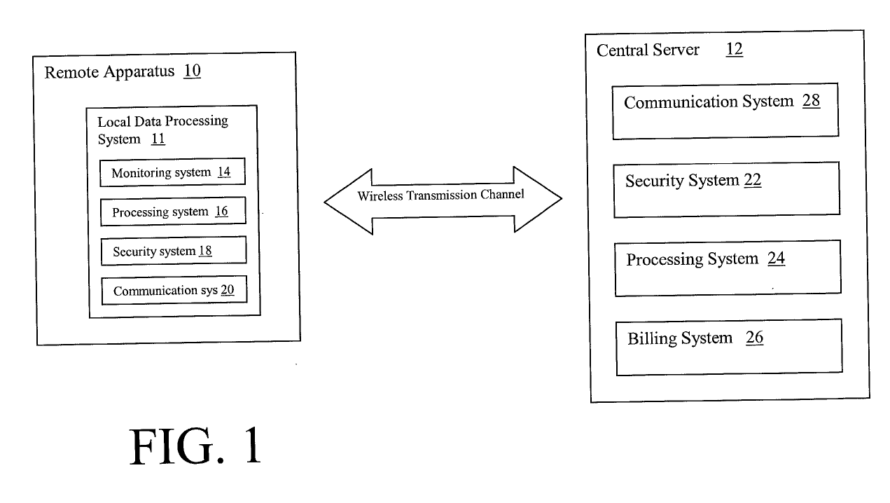

Referring now to FIG. 1, a general overview of an exemplary remote usage monitoring system is shown, which includes a remote apparatus 10 having a local data processing system 11, and a central server 12. The local data processing system 11 may be embedded in the remote apparatus 10. The remote apparatus 10 may comprise any device or object, including, but not limited to, a vehicle, a boat, an aircraft, a tool, a construction apparatus, a household appliance, a medical device, exercise equipment, a heating/air conditioning system, a dwelling, a mechanical device, an electronic device, a factory, a commercial establishment, an insurable object, etc. Local data processing system 11 is in communication with the central server 12 via a wireless transmission channel. For the purposes of this application, a “customer” may be defined as any one of the operator, owner, user, insured, responsible party, subscriber, etc., of the remote apparatus 10.

Local data processing system 11 comprises a monitoring system 14 for collecting usage data from the remote apparatus 10. The monitoring system may comprise one or more sensors that measure or analyze activity (e.g., speed, location, weight, distance traveled, acceleration, seatbelt usage, braking, etc.) of the apparatus. Local data processing system 11 may further comprise a processing system 16 for processing the usage data. The processing system 16 may comprise a processor and software programs capable of analyzing the usage data and generating a charge. Local data processing system 11 may further comprise a security system 18 for ensuring privacy, security and confidentiality for data being collected, processed and communicated. Details of the security system 18 are described below. In addition, local data processing system 11 may further comprise a communication system 20 for communicating information, such as charges, raw usage data, or requests for data, to central server 12.

Central server 12 may include a communication system 28, a security system 22 for decrypting and maintaining security for communicated information, a processing system 24, and a billing system 26 for obtaining payments. Central server 12 may be controlled by the entity insuring or renting the apparatus, a service provider, or a third party (collectively referred to herein as “company”).

The following two exemplary cases may be utilized to securely determine a charge. In the first case, charges are calculated locally at the remote apparatus 10. This ensures that usage data, such as where and how the apparatus is being used, does not leave the apparatus and is therefore kept private (i.e., the usage data cannot be intercepted during transmission or disseminated by the company). In this case, data is acquired, calculations are performed, and the results of the calculation (charges or modification to the charges) are stored in a local secure computing system, e.g. an IBM 4758 PCI Cryptographic Coprocessor (hereafter 4758) within the local data processing system 11. The results of the calculations are stored at least temporarily in a secure manner, e.g. using the 4758 or some other storage device. The usage data, the calculation, the results of the calculation are protected by virtue of being stored in the 4758. The data may be encrypted with a key available only to the customer. The results, e.g., charges, will be communicated to the company via central server 12 and may be protected by encryption using a key that is known by the company for protecting the customer and the company against third parties. Usage data may also be transmitted to the company to be stored in the company computer. In order to ensure privacy, usage data is encrypted with a key known only to the customer.

In the second case, some or all of the usage data acquisition or calculation is not done locally at the remote apparatus 10. It may be performed at the central server 12, or at a third party's computer. In case a request for data and/or for a quotation cannot be fulfilled by the local computer at the customer location, requests can be handled in the following exemplary manner, with respect to insuring a vehicle, in order to protect the anonymity of the customer.

A local secure computing system (n) in the customer's vehicle establishes a secure and authenticated communication path to a receiving system or base station (m) belonging to the insurance company, its representative, or an intermediary data acquisition company, using a known and standard secure protocol (e.g., SSL, IPSec, SSH, etc.). Requests and associated data, possibly digitally signed for authentication and non-repudiation reasons, and encrypted under the public key of the insurance company for confidentially purposes, are forwarded from m to the insurance company's request processing systems (i.e., central server 12) over similarly secured and authenticated communication links. Central server 12 may in turn use back office systems and databases, or even third party information providers, to fulfill the request. Additionally, all communications between request processing systems and back office systems/databases may also be secured by known protocols. Digitally signed receipts are returned for all requests, and audit logs of all request-response transactions are time stamped, digitally signed, and securely stored for future reference (e.g., billing, data mining, etc.).

In either embodiment, charges may be calculated and/or relayed to the central server 12 where the charges are assessed by means of, e.g., a credit card payment system. The charges may be added to produce a total sum or may be divided into increments of time or usage. Using a credit card payment system, mini-payments for incremental usage may be obtained. In certain applications, customers using a credit card could, for example, change or lower the total cost of insurance with respect to a fixed price insurance policy. In addition to fee or charge determination, the calculations may be used to determine risk. For example, if a driver is found to engage in an excess amount of undesired activity, e.g. speeding, then that driver may be assigned to a high-risk group of insurance subscribers.

II. Security System

For the purposes of describing an exemplary security system, a system is disclosed that collects usage information from a vehicle for determining insurance costs. However, it should be understood that the security system of the present invention could be applied to any system that collects usage information from a remote apparatus.

A. Protection Against Tampering:

Because charges are allocated based on end-user usage of an apparatus, it is important to protect against tampering of the collected data. Various types of protection against tampering can be utilized. For example, in the case of an automobile, it is preferable to include a system that will either: (1) make it very hard for the user to replace data with falsified data, to suppress data, or to generate falsified data; or (2) include equipment that will leave traces that tampering, and/or tampering attempts have taken place.

Various known systems exist to provide these solutions. For instance, U.S. Pat. No. 5,159,629, DATA PROTECTION BY PROTECTION OF INTRUSION INTO ELECTRONIC ASSEMBLIES, issued to Double et al., and hereby incorporated by reference, provides a system for protecting against intrusion into electronic equipment. Additional co-pending patent applications, which are also incorporated by reference, include: METHOD AND APPARATUS FOR PRODUCING DUPLICATION-AND IMITATION-RESISTANT IDENTIFYING MARKS ON OBJECTS, AND DUPLICATION-AND IMITATION-RESISTANT OBJECTS, filed on Sep. 17, 1999 as application Ser. No. 09/397,503; EVENT-RECORDER FOR TRANSMITTING AND STORING ELECTRONIC SIGNATURE DATA, filed on Jan. 20, 1999 as application Ser. No. 09/233,487; and METHOD AND APPARATUS FOR SECURELY DETERMINING ASPECTS OF THE HISTORY OF A GOOD, filed on Jan. 11, 1999 as Ser. No. 09/228,231.

A specific solution for the present invention would be to cover part or all of the components of the local data processing system 11 in a layer of epoxy that contains a signature embedded in a random pattern of bubbles, and/or random magnetic inclusions. Optical (for the bubbles configuration) and magnetic (for the randomly place magnetic inclusions) readings of each such covered component could be monitored to ensure that no tampering has taken place. Moreover, instead of using wireless transmission components among the components in the local data processing system 11, wired communications could be used. In a vehicle application, a bus that services all of the electrical components in the car could be utilized. The bus that connects the various components need not be secure itself (since this may make its other uses in car control and operation more difficult) as long as cryptography and other secure controls as described below are implemented.

To secure data flow amongst the components in the remote apparatus 10, a private/public key pair could be utilized such that bubble and/or magnetic data, along with a number that designates the car, can be signed using a private key, and written on the car. If the epoxy (as described above) is destroyed to tamper with the particular component, or if a new component replaces the legitimate one, a correct signature cannot be obtained and tampering will be evident. In this embodiment, the public part of the key allows anyone to easily check the genuine character of the installation using standard procedures.

In order to avoid problems associated with falsified data, the components may talk to each other using classical cryptographic protection. Clocks embedded in the transmission units of each component can ensure that data is being properly exchanged to, e.g., describe vehicle motion and its characteristics, or the absence of motion. Falsified data cannot be fed into a component because of the cryptographic protection. If charge and rate computations are done locally, using secure hardware can protect the computations.

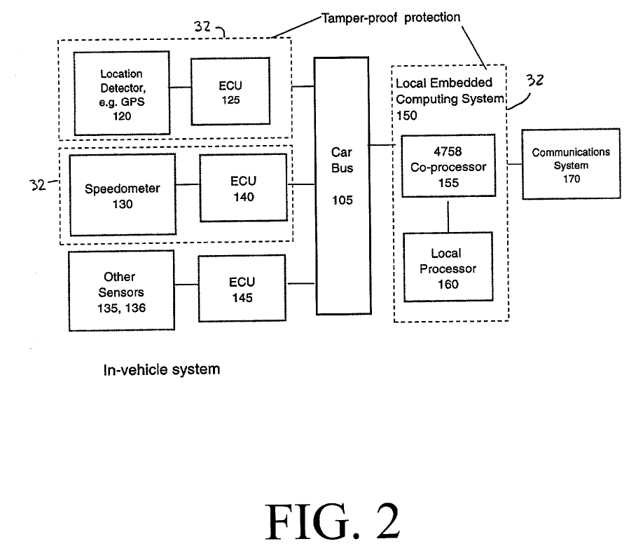

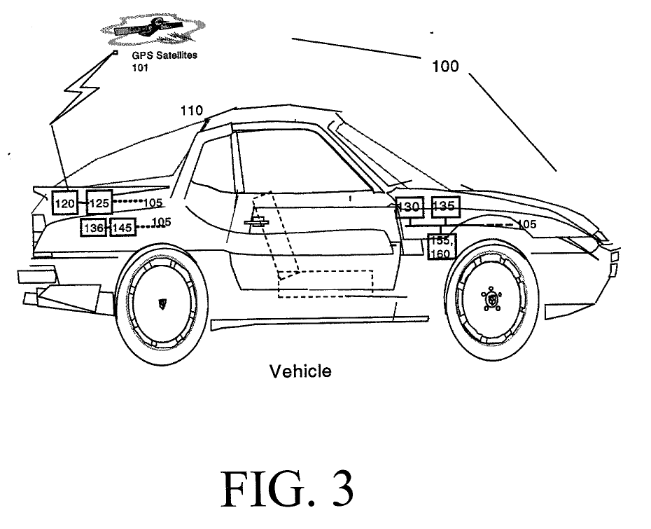

FIGS. 2-3 depict an exemplary secure data processing application (see FIG. 2) for use within a vehicle 100 (see FIG. 3). The application includes various sensors for collecting usage data, including a GPS location detector 120 that can obtain time and location data from GPS satellites 101, a speedometer 130, and other sensors 135, 136 (e.g., odometer, accelerometer, weight, seatbelt usage, braking, etc.). Each sensor is in communication with an electronic control unit (ECU) 125, 140 and 145. Each ECU communicates with a local embedded computing system 150 via the car bus 105. The local embedded computing system 150 processes the collected usage data with, for example, a local processor 160 and an IBM 4758 co-processor 155 running a software application. The processed data is transmitted to a central server via communications system 170. Any algorithm for calculating a charge, or otherwise processing the usage data could be used.

In this exemplary embodiment, some of the components are packaged using a tamper resistant system, e.g., epoxy (represented by the dashed lines 32). As can be seen, it is possible that only some of the components need to be made tamper resistant, e.g., those considered critical.

B. Installation

Because vehicles and other insured or rented apparatuses may change ownership from time to time, and customers may change insurance companies, a flexible system for installing and maintaining the security must be utilized. Depending on the scenario, the security system may be installed and/or maintained by various entities. For instance, either a car manufacturer or an after-market entity (e.g., a rental car company or insurance provider) could install a sensor system and communication and/or computation devices.

The sensors and devices making up the security system may be pre-initialized with the appropriate public/private key pairs and public key certificates, or they could be self initializing, perhaps self-certifying the necessary public/private key pairs that they generate. In either case, a hierarchy of public keys and certificate authorities should be employed which would allow for some or all of the following: (1) the replacement of defective devices and integration of new/additional devices into the system (e.g., discovery and initialization with appropriate public/private key pairs and certificates); (2) transfer of the system to new ownership or monitoring authority (e.g., user/owner sells the vehicle or changes insurance providers); (3) the possibility of multiple, virtually simultaneous, providers (e.g., allowing the user/owner to determine in real time the best provider and rate at the time); and (4) secure update and configuration, e.g. software and database tables, etc.

Also, the secure computing platform, used for charge determination and/or securely managing data storage or communication with the central server 12 should allow for the secure update and execution of software/programs and/or data (e.g., configuration parameters such as privacy policy imperatives, coverage initiation data, etc.) provided by, e.g., an auto manufacturer, insurance companies or their representatives, or the customer (e.g., privacy policy parameters).

In one scenario involving a car and an insurance company, the car manufacturer installs sensors and communication devices securely linked to each other, and to a secure processor SP in the car c. The new SP can only use a single composite key, K1, to communicate to the rest of the world. When c is sold to customer C1, C1 is given K1, and C1 uses it to define a new unique key K2. Standard user-friendly technology may be utilized for this. C1 can then make as many copies of K1 as needed. A third party company can be utilized to host backups of K1, in the event it is lost. When C1 sells c to another customer C2, K2 is communicated to C2, who can then change it to K3, etc.

Whenever a new customer takes ownership of the car, part of their active key Kn can be communicated to the company monitoring usage (e.g., an insurance company). The communicated potion of the key should provide the company with enough capabilities to communicate with SP, but not enough to change the key or interrogate the secure database in SP. When a customer changes companies, the customer should also change the key Kn to new key K(n+1).

In a second scenario, the company collecting the usage data (e.g., an insurance company) can install the secure sensors and processors in the customer's car. In this case, each new SP will only use a single key K1 to communicate with the rest of the world.

C. Data Processing

There are two main cases for the way rates or charges are computed based on collected usage data. In the first embodiment, data is acquired, calculations are performed and the results of the calculation (charges or modification to the charges) are stored in a secure local embedded computing system 32 containing, e.g. an IBM 4758 CPI coprocessor. The results of the calculations are stored, at least temporarily, in a secure manner, e.g. using the 4758. The data, the calculation, and the results of the calculation are protected by virtue of being stored in the 4758, which is tamper resistant. The data may be encrypted with the key available only to the customer. The results, i.e., charges, will be communicated to the company and may be protected by encryption using a key that is known by the company for protecting both the customer and the company against third parties. The data may also be transmitted to the company for storage in the company computer. In order to ensure privacy, this data is encrypted with a key known only to the customer.

In a second case, some or all of the data processing is not done locally. It may be performed at the company's or a third party's remote computer. In this case, a request R for data and/or for a quotation cannot be directly fulfilled by the remote computer at the customer location. Instead, a data handling process, as described below, can be utilized to manage secure data transactions between the company and the remote computer.

D. Data Handling

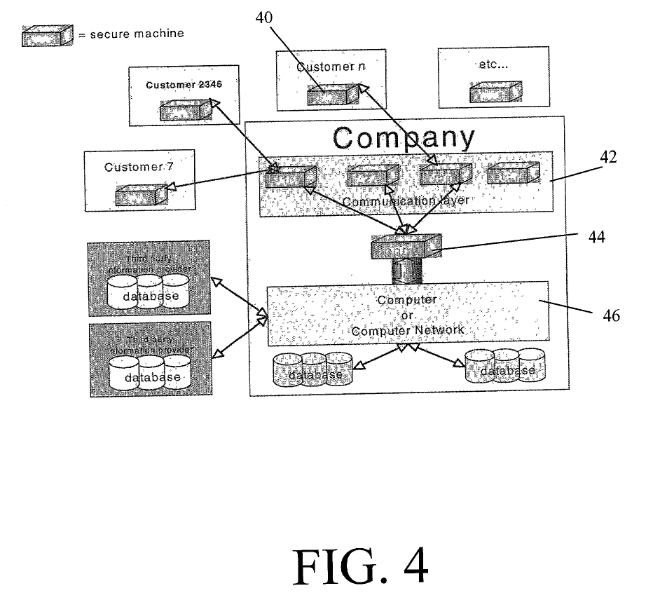

Referring now to FIG. 4, a secure network for collecting usage data from customers having local computing systems is shown. First, the local computer 40 of a customer, called n (the local computer of any customer is the pool of customers) prepares a Request R, e.g., for data, quotations, software updates, etc., according to some preset format. In accordance with the above description, a Request R may comprise calculated charges or usage information that needs to be communicated to the central server. Using a random number generator and a list of contact information about the secure computers 42 devoted to communication at the company's location, n chooses at random one of the secure partners, called m, at the company's location. All communications will preferably use standard guaranteed delivery capabilities, where messages are kept in the memory of the sender at least until reception is acknowledged and integrity of the transmission is checked. Using standard secure communication techniques, such as describe for instance in “Handbook of applied Cryptography”, by Alfred J. Menezes, Paul C. van Oorschot and Scott A. Vanstone, CRC Press, 1997, m and n can recognize each other as legitimate and establish a communication key K for the session (e.g., using any known protocol).

The local computer n then encrypts R using key K and sends the encryption K(R) to the secure partner m. Then, using the inverse K−1 of K, m can recover R from K(R) as K−1(K(R)). Next, before sending the request R to the processing facilities, m attaches a specific tag T to R so that m can associate R with n. T can be any unique random number that can be logged by m. Once T has been selected, m logs that the tag T corresponds to n in an internal, secure memory that cannot be read by any other machine but m. Then the secure partner m encrypts the pair (R,T) to k(R,T), using an internal communication key k that serves for communication between the secure partners and the Central secure unit 44 (hereinafter, “Central”).

The secure partner m can group some number N of encrypted pairs, and send the group to Central 44. The pairs can be randomly reordered to prevent traffic tracking. Central 44 then extracts (R,T) using k−1(k(R,T)) from k(R,T). Central 44 then logs that T corresponds to secure partner m in an internal, secure memory. Central 44 may also create a new tag for use in communications outside of the secure components. Central 44 then sends the non-encrypted pair (R,T) to a main computer/database infrastructure 46 (hereinafter “Main”). Main 46 then fulfills R, or may provide a response message, e.g., “R cannot be fulfilled.” In this case, an alert may be raised to check why a request could not be fulfilled. The fulfillment of the request or the response message is referred to as an Answer, or A.

Next, Main 46 sends the pair (A,T) to Central 44, using a guaranteed delivery messaging such as an MQ series. Central 44 then groups several (A,T) pairs and reorders them randomly to prevent traffic tracking. Central 44 recognizes m from T using its log, and sends k(A,T) to secure partner m. Secure partner m can then decrypt k(A,T) with k−1, ensure that A is in the proper format, and acknowledge reception back to Central 44. If proper delivery is not made, recovery mechanisms may be invoked, e.g., if after some time, a proper transmission is not made, Central 44 can sign a non-delivery acknowledgment and raise an alert. Once proper delivery to m is checked, Central 44 erases the log of the pair (T,m). On its side, m recognizes n from the tag T using its own log. Then m sends K(A) to n. Local computer n then decrypts K(A), recognizes proper format, and acknowledges reception to m, at which point in time m erases the log of the pair (T,n).

In addition, the network can be set up such that n will prompt m for answers to R if an answer is not received within a preset time. Moreover, data can also be stored in a format that is accessible to authorities, and protected by the need of a proper search warrant.

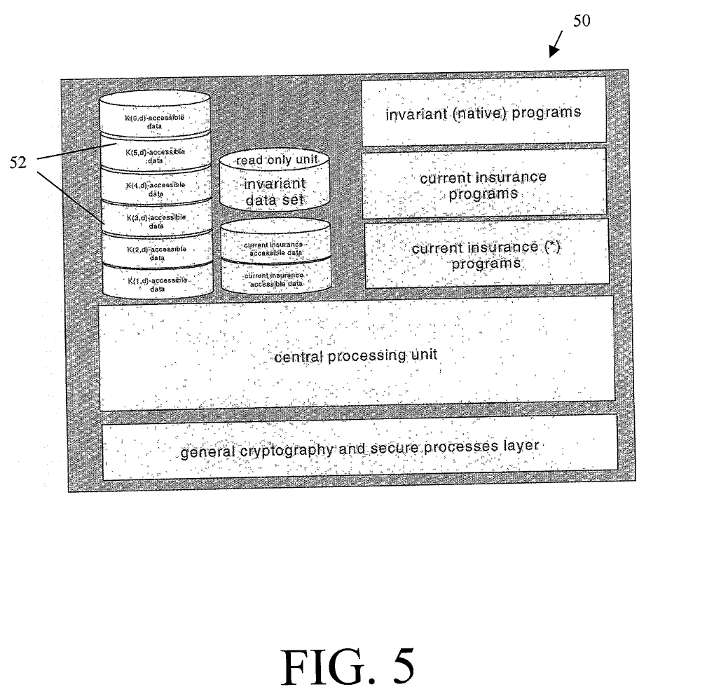

Referring now to FIG. 5, an exemplary local secure computing system 50 is shown having a software stack 52 for maintaining encryption keys. The local secure computing system 50 can be partitioned with varied access controls. Several cryptographic keys, which together may form a composite key as described below, provide access to specific data or programs, and also provide security for the main controls of the secure computer. For instance, in the case of a car, the car may be sold, and/or the owner may wish to change insurance carriers. In this case, the cryptographic keys should change. It is convenient to consider that at any point in time, there is a composite key, made of several traditional keys with different purposes. A possible structure of the composite key Kn (the nth such composite key) for a given car for an insurance company is as follows:

Kn=(K(n,c),K(n,d),K(n,i),K(n,e),K(n,w)),

where:

K(n,c) provides a mechanism to change Kn to K(n+1). In this case, co-use of a car-dealer key or an insurer key may be needed to operate the change.

K(n,d) provides a mechanism to read any data generated while Kn is the valid key (even if Kn is no longer the valid key), or to erase globally the data generated under any former key. The processor posseses the inverse of K(n,d). Preferably, either this inverse is inaccessible to the user, or the data can only be produced by the operation of the car as guaranteed by the software and/or cabling.

K(n,i) allows chosen insurance partners to install specific pricing (and optionally communication) programs. In this case, either co-use of an insurer key is needed, or only packages globally signed by an insurance company can be installed, and such packages may need to be also signed by some regulatory body. K(n,i) would typically be provided by the insurance provider.

K(n,e) provides a mechanism to encrypt and decrypt data on behalf of the customer. It can be optional and may be used to encrypt a backup of the data to be stored at the insurer or third party location.

K(n,w) allows wireless secure communication. This may be optional as all processing can be done in the local computer on board the car. However, even if processing is done locally, it can be used if data is stored at the insurance location for backup. Back-up data can be encrypted, e.g., using K(n,d) if it is a symmetric cryptosystem, or K(n,e). K(n,w) would typically be provided by the insurance provider.

III. Remote Monitoring of Aberrant Usage

One embodiment of this invention is to monitor and assess costs for aberrant (i.e., non-standard) usages of remote apparatuses. For example, when an apparatus is rented to a customer, or covered by insurance for the customer, it may be valuable for the rental or insurance company to know when the apparatus is being used in aberrant manner. For instance, if an insured motorist habitually drives their car in a reckless manner, then their insurance rate should be higher to reflect their driving style. Similarly, if an expensive piece of machinery (e.g., a dump truck) is rented to a customer, and the customer overloads the dump truck, the rental company may want to charge additional expenses. By collecting such information, companies can better mange costs, and keep rental and insurance costs lower for those customers who operate the particular apparatus in a non-aberrant manner.

It is understood that the systems, functions, mechanisms, methods, and modules described herein can be implemented in hardware, software, or a combination of hardware and software. They may be implemented by any type of computer system or other apparatus adapted for carrying out the methods described herein. A typical combination of hardware and software could be a general-purpose computer system with a computer program that, when loaded and executed, controls the computer system such that it carries out the methods described herein. Alternatively, a specific use computer, containing specialized hardware for carrying out one or more of the functional tasks of the invention could be utilized. The present invention can also be embedded in a computer program product, which comprises all the features enabling the implementation of the methods and functions described herein, and which—when loaded in a computer system—is able to carry out these methods and functions. Computer program, software program, program, program product, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of the invention have been presented for purposes of illustration and description. They are not intended to be exhaustive or to limit the invention to the precise form disclosed, and obviously many modifications and variations are possible in light of the above teachings. Such modifications and variations that are apparent to a person skilled in the art are intended to be included within the scope of this invention as defined by the accompanying claims.

1. A system for processing usage data within a local data processing system installed on a remote apparatus, wherein the local data processing system comprises:
a sensor for gathering usage data from the remote apparatus; and
a processor for processing the gathered usage data and calculating a charge based on the gathered usage data.

2. The system of claim 1, further comprising a communications system for transmitting the calculated charge to a central server via a wireless transmission channel.

3. The system of claim 2, further comprising a security system, wherein the security system comprises a tamper resistant encasement that encases at least one component of the local data processing system.

4. The system of claim 3, wherein the at least one encased component comprises the processor.

5. The system of claim 3, wherein the at least one encased component comprises the sensor.

6. The system of claim 3, wherein the tamper resistant encasement comprises an epoxy having a signature embedded therein.

7. The system of claim 1, further comprising a security system, wherein the security system comprises an encryption system for encrypting usage data transmitted between the sensor and the processor.

8. The system of claim 2, further comprising a security system, wherein the security system comprises an encryption system for encrypting data communicated by the communications system.

9. The system of claim 1, wherein the processor comprises a cryptographic coprocessor.

10. The system of claim 1, wherein the charge comprises an insurance cost.

11. The system of claim 1, wherein the charge comprises a rental cost.

12. The system of claim 1, wherein the remote apparatus is selected from the group consisting of: a vehicle, a boat, an aircraft, a heating system, a home appliance, a medical device, a dwelling, a factory, a commercial establishment, and an insurable object.

13. The system of claim 1, wherein the sensor measures a speed of the apparatus.

14. The system of claim 1, wherein the sensor collects data from a GPS system.

15. The system of claim 1, wherein the sensor measures weight placed on the remote apparatus.

16. A system for managing usage data collected on a remote apparatus, comprising:
a local data processing system having:
a monitoring system for gathering usage data from the remote apparatus;
a processor for processing the usage data;
a communications system for communicating the processed usage data; and
a security system for securing the usage data.

17. The system of claim 16, wherein the security system includes a tamper resistant encasement for securing the processor.

18. The system of claim 16, wherein the security system includes an encryption system for encrypting usage data communicated from the monitoring system to the processor.

19. The system of claim 16, further comprising a central server for receiving the processed usage data and securing a usage payment, wherein the usage payment is determined from the processed usage data.

20. The system of claim 19, wherein the security system further comprises a second encryption system for encrypting data transmitted between the communications system and the central server.

21. The system of claim 20, wherein the usage payment comprises an insurance payment.

22. The system of claim 20, wherein the usage payment comprises a rental payment.

23. A system for managing usage information collected on a remote apparatus, comprising:
a central server for receiving information from the remote apparatus, and processing the information to obtain a usage payment; and
a local data processing system installed on the remote apparatus, having:
a monitoring system for gathering usage data from the remote apparatus;
a processor for managing the usage data;
a communications system for communicating information from the processor to the central server; and
a security system, wherein the security system includes an encryption system for securing information transmitted to the central server, and for securing information processed by the central server.

24. The system of claim 23, wherein the usage payment comprises an insurance payment.

25. The system of claim 23, wherein the usage payment comprises a rental payment.

26. A method of securely communicating data between remote apparatuses and a central server, comprising the steps of:
generating data D on a first apparatus;
encrypting the data D with a first key K to generate K(D);
transmitting K(D) to a secure partner of the central server;
decrypting K(D) at the secure partner to recover D;
appending a tag T to D and encrypting D and T with a second key k to generate k(D,T), wherein T associates data D with the first apparatus;
transmitting k(D,T) to the central server;
decrypting k(D,T) at the central server to recover D and T; and
processing data D at the central server.

27. The method of claim 26, further comprising:
generating a response A in response to the processing of D;
encrypting A and T with the second key k to generate k(A,T);
transmitting k(A,T) to the secure partner;
decrypting k(A,T) at the secure partner to recover A and T;
encrypting A with first key K to generate K(A);
transmitting K(A) to the first apparatus; and
decrypting K(A) at the first apparatus to recover response A.

28. The method of claim 26, wherein D comprises usage data monitored from apparatus A.

29. The method of claim 28, wherein the central server calculates an insurance charge based on data D.

30. The method of claim 28, wherein the central server calculates an insurance charge based on data D.

31. The method of claim 26, wherein the first apparatus is selected from the group consisting of: a vehicle, an aircraft, a boat, a medical device, a dwelling, a factory, a commercial establishment, and an insurable object.

32. The method of claim 26, wherein D comprises a request for a rate quotation and A comprises a rate.

33. A method for managing usage data collected on a remote apparatus, comprising:
providing a sensor on the remote apparatus to gather usage data;
communicating the usage data to a processor located on the remote apparatus;
calculating a charge on the processor based on the usage data; and
communicating the charge to a server via a wireless transmission channel.

34. The method of claim 33, further comprising:
obtaining an electronic payment based on the charge.

35. The method of claim 33, wherein the charge is an insurance cost.

36. The method of claim 33, wherein the charge is a rental cost.

37. The method of claim 33, wherein the usage data is encrypted prior to being communicated to the processor.

38. The method of claim 33, wherein the charge is encrypted prior to being communicated to the server.
